(19) United States
(12) Patent Application Publication
(10) Pub. No.: US 2026/0369157 A1
(43) Pub. Date: Nov. 19, 2026

(54) TRANSMITTING EVENT MESSAGES TO EVENT RESPONSE STATIONS

(71) Applicant: Honeywell International Inc., Charlotte, NC (US)

(72) Inventors: Eric G. Dickinson, Tempe, AZ (US); David Maurer, Chandler, AZ (US); Jeffrey J. Pristelski, Phoenix, AZ (US); Sourabh Makker, Mumbai (IN); Uvaraj Thangarajan, Kanchipuram (IN); RajeshBabu Nalukurthy, Bengaluru (IN)

(21) Appl. No.: 19/207,861

(22) Filed: May 14, 2025

(51) Int. Cl. G08B 27/00; G08B 25/00

(52) U.S. Cl. CPC G08B 27/005; G08B 25/006; G08B 27/001

(57) ABSTRACT

Devices, systems, and methods for transmitting event messages to event response stations are described herein. In some examples, one or more embodiments include a memory and a processor to execute instructions stored in the memory to receive an event notification from a control panel of a facility indicating an event was detected in the facility, determine, based on the event notification, an event response station from a number of event response stations using a mapping database, where the control panel has a predetermined association with the event response station in the mapping database, and transmit an event message to the event response station.

### TECHNICAL FIELD

The present disclosure relates to devices, systems, and methods for transmitting event messages to event response stations.

### BACKGROUND

Facilities, such as commercial facilities, office buildings, hospitals, campuses (e.g., including buildings and outdoor spaces), and the like, may have an event detection system that can be triggered during an event, such as an emergency situation (e.g., a fire) to warn occupants to evacuate. Such an event detection system may include an alarm system having a control panel and a number of event devices (e.g., sensors, sounders, pull stations, etc.) located throughout the facility (e.g., on different floors and/or in different rooms of the facility) that can perform an action when an event (e.g., a hazard event, a fault event, etc.) is occurring in the facility. In an example of an event, the number of event devices may provide a notification of the event to the occupants of the facility via alarms and/or other mechanisms.

### BRIEF DESCRIPTION OF THE DRAWINGS

FIG. 1 is an example of a system for transmitting event messages to event response stations, in accordance with one or more embodiments of the present disclosure.

FIG. 2 is an example of a mapping input for transmitting event messages to event response stations, in accordance with one or more embodiments of the present disclosure.

FIG. 3 is an example of a method for transmitting event messages to event response stations, in accordance with one or more embodiments of the present disclosure.

FIG. 4 is an example of a method for transmitting event messages to event response stations, in accordance with one or more embodiments of the present disclosure.

FIG. 5 is an example of a method for transmitting event messages to event response stations, in accordance with one or more embodiments of the present disclosure.

FIG. 6 is an example of a computing device for transmitting event messages to event response stations, in accordance with one or more embodiments of the present disclosure.

### DETAILED DESCRIPTION

Devices, systems, and methods for transmitting event messages to event response stations are described herein. In some examples, one or more embodiments include a memory and a processor to execute instructions stored in the memory to receive an event notification from a control panel of a facility indicating an event was detected in the facility, determine, based on the event notification, an event response station from a number of event response stations using a mapping database, where the control panel has a predetermined association with the event response station in the mapping database, and transmit an event message to the event response station.

A facility can utilize an event detection system in order to warn occupants of the facility of an emergency event, such as a fire or other events. An event detection system can be a system of devices that operate to collect information about a facility and provide the collected information for analysis. Such an event detection system can also take actions based on the collected information, such as providing an audible and/or visible warning in an emergency event. For example, the event detection system can utilize event devices to warn occupants of an emergency event occurring in a space, such as a fire. As used herein, the term “event device” refers to a device that can receive an input relating to an event and/or generate an output relating to an event. Such event devices can be a part of the event detection system of a space in a facility/in the facility at large and can include devices such as fire sensors, smoke detectors, heat detectors, carbon monoxide (CO) detectors, or combinations of these; air quality sensors; interfaces; manual call points (MCPs); pull stations; input/output modules; aspirating units; fire doors; and/or audio/visual devices (e.g., speakers, sounders, flashers, buzzers, microphones, cameras, video displays, video screens, etc.), relay output modules, among other types of event devices. Such event devices may also include self-test capabilities.

When an event is detected by an event device, information is transmitted by an event device to a control panel of the event detection system. For example, if a smoke detector detects smoke, the smoke detector transmits information to a control panel for analysis.

Upon detection of an event and upon receiving the information from the event device, the control panel contacts a central monitoring station in order to alert the central monitoring station to the detected event. This process includes the control panel calling (e.g., using a public switched telephone network) via a phone call the central monitoring station to alert the central monitoring station of the detected event. The central monitoring station then places a phone call to a user at the facility (e.g., a building owner, engineer, maintenance, etc.) to verify the detected event.

Once the event is verified, the central monitoring station places a phone call to emergency response dispatch. The central monitoring station can place the phone call to alert the emergency response dispatch of the detected event (e.g., smoke in the facility). Once the emergency response dispatch is alerted to the detected event, the emergency response dispatch can determine a particular emergency response station to contact to dispatch emergency response units to address the detected event. For example, the emergency response dispatch can contact a fire station to dispatch firefighters to the facility.

As illustrated above, such an approach involves different levels of communication between many different parties. Additionally, the levels of communication between the event device/fire panel in the facility to an emergency response station can take valuable time. In some examples, such communication may take upwards of five minutes or more.

When an event at a facility is detected that may be an emergency situation, reducing the amount of time to respond to the event can be crucial. For example, reducing the amount of time to respond to the event can increase chances of survival for occupants who may be trapped in the facility, reduce damage that may occur to the facility as a result of the event, etc.

Transmitting event messages to event response stations according to the disclosure can allow for efficient transmission of event messages from a fire panel to an event response station. An event message can be quickly transmitted to an event response station via a computing device in order to initiate an event response, such as close monitoring and/or dispatch of emergency response units to an event, according to various examples described herein. Additionally, emergency response stations can selectively monitor different geographic areas allowing for efficient emergency response coverage for a geographic region. Such an approach can make facilities safer by allowing for faster response to an event by emergency response units, as compared with previous approaches.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

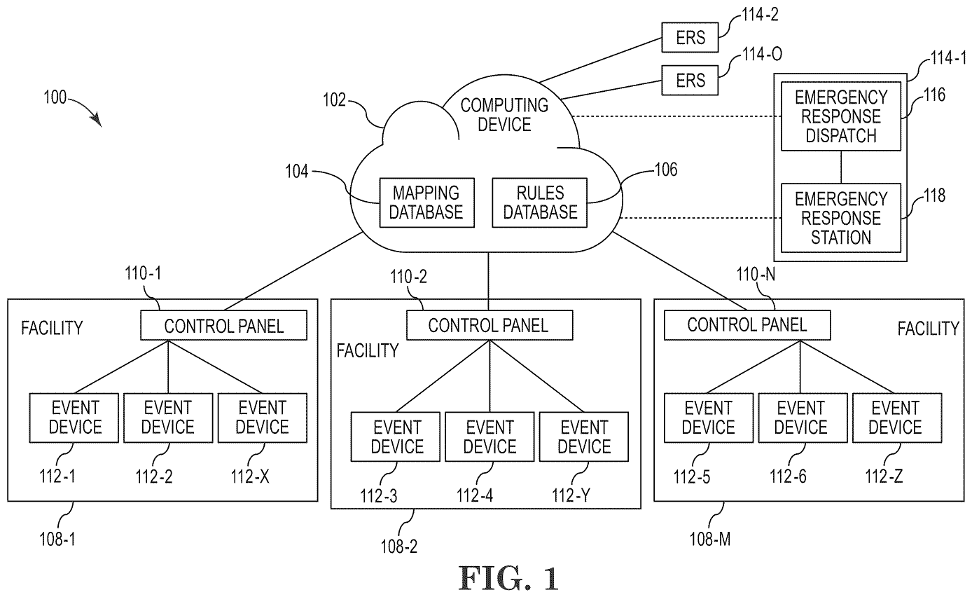

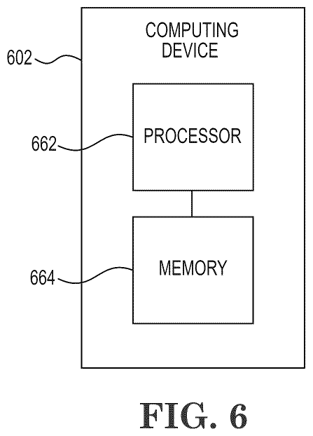

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 602 in FIG. 6.

As used herein, “a”, “an”, or “a number of” something can refer to one or more such things, while “a plurality of” something can refer to more than one such things. For example, “a number of components” can refer to one or more components, while “a plurality of components” can refer to more than one component. Additionally, the designators “M”, “N”, “O”, “X”, “Y”, and “Z”, as used herein, particularly with respect to reference numerals in the drawings, indicates that a number of the particular feature so designated can be included with a number of embodiments of the present disclosure.

FIG. 1 is an example of a system 100 for transmitting event messages to event response stations, in accordance with one or more embodiments of the present disclosure. The system 100 can include a computing device 102 and a number of control panels 110-1, 110-2, 110-N (collectively referred to herein as control panels 110). The computing device 102 can include a mapping database 104 and a rules database 106. Each of the control panels 110 can include respective event devices 112-1, 112-2, 112-X, 112-3, 112-4, 112-Y, 112-5, 112-6, 112-Z (collectively referred to herein as event devices 112) associated therewith. Additionally, each of the control panels 110 can be a part of a respective facility 108-1, 108-2, 108-M. Further, the system 100 can include event response stations 114-1, 114-2, 114-O (referred to collectively herein as event response stations 114).

As mentioned above, a computing device 102 can be utilized to efficiently transmit an event message from a control panel 110 to an event response station 114. As illustrated in FIG. 1, the system 100 can include the computing device 102.

As used herein, the term “computing device” refers to an electronic system having a processing resource, memory resource, and/or an application-specific integrated circuit (ASIC) that can process information. Examples of computing devices can include, for instance, a laptop computer, a notebook computer, a desktop computer, an All-In-One (AIO) computing device, server computing devices, computing devices included in and/or making up a cloud-computing environment, networking equipment (e.g., router, switch, etc.), and/or a mobile device, among other types of computing devices.

As illustrated in the system 100 of FIG. 1, the computing device 102 can be remotely located from the control panels 110. The computing device 102 can be a computing device included as part of a cloud-computing environment. For instance, the computing device 102 can be a computing device operating as part of a cloud computing environment remotely located from the control panels 110 and can receive data from the control panels 110 via a network relationship.

The control panels 110 can be connected to the event devices 112, transmit a plurality of commands to the event devices 112, and/or provide power to the event devices 112. The control panels 110 can apply a voltage to an event device loop in order to power event devices 112 on the event device loop. Such power can allow the event devices 112 to perform actions, such as communication between event devices 112 and the control panel 110, self-test procedures, and/or provide an audible and/or visible warning in an event, among other actions.

The control panels 110 can be connected to the computing device 102 and/or to the event devices 112 via a wired and/or wireless network relationship. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), Near Field Communication (NFC), infrared (IR) communication, Public Switched Telephone Network (PSTN), radio waves, and/or the Internet, among other types of network relationships.

Additionally, as illustrated in FIG. 1, the system 100 can include event response stations 114. As used herein, an event response station is an entity that can receive an event message, relay the event message to another entity, and/or dispatch emergency response units in response to receiving the event message.

For instance, in some examples, the event response station 114-1 can be an emergency response dispatch 116. As used herein, the emergency response dispatch 116 can be an entity which can receive event messages, process event messages, and/or dispatch emergency response units to an event. For example, the emergency response dispatch 116 can be a 911 dispatch center that can receive an event message, process the event message, and dispatch emergency response units (e.g., police, firefighters, emergency medical services (EMS), hazardous material response (HAZMAT), etc.) to respond to the event.

In some examples, the event response station 114-1 can be an emergency response station 118. As used herein, an emergency response station 118 can be an entity at which emergency response units are located. For example, the emergency response station 118 can be a police station, fire station, EMS station, HAZMAT station, and/or any other type of station at which emergency response units are located.

As illustrated in FIG. 1, multiple event response stations 114 can be connected to the computing device 102. Although not illustrated in FIG. 1 for clarity and so as not to obscure embodiments of the disclosure, each of the event response stations 114 can include an emergency response dispatch 116 and/or an emergency response station 118. Additionally, any and/or all of the emergency response dispatches and/or emergency response stations making up the event response stations 114 can be connected to the computing device 102 via a type of network relationship previously described above.

As mentioned above, the computing device 102 can facilitate transmission of event messages to event response stations 114. Such an approach can reduce a time to respond to an event by emergency response units, as is further described herein.

The computing device 102 can receive a mapping input. As used herein, a mapping input refers to an association between a facility and an event response station tasked with responding to events from that facility. For example, a mapping input can define a particular facility 108 that an event response station 114 monitors and responds to. For instance, the computing device 102 can receive a mapping input that associates the event response station 114 (e.g., including the emergency response dispatch 116 and/or the emergency response station 118) with facility 108-1. Accordingly, if an event device 112-1 in the facility 108-1 detects an event, the event device 112-1 transmits information about the detected event to the control panel 110-1, the control panel 110-1 transmits an event notification about the detected event to the computing device 102, and the computing device 102 determines the appropriate event response station 114 to transmit an event message to based on the mapping input, as is further described herein.

The mapping input can include data allowing for a predetermined association to be created by the computing device 102 between an event response station 114 and a control panel 110 of a facility 108. For example, the mapping input can include a geographic monitoring area in which a facility 108 is located, selected (e.g., predefined) emergency response units to respond to detected events in the geographic monitoring area, and emergency response rules. The mapping input can be received from an external computing device (e.g., not illustrated in FIG. 1) and/or via a user input to the computing device 102.

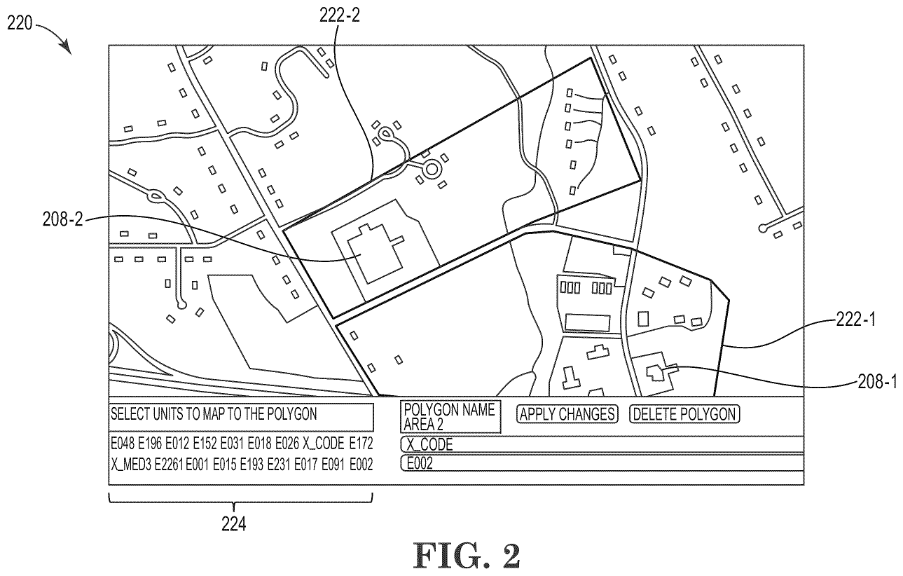

The geographic monitoring area can include a geographic area in which a facility, such as facility 108-1, is located. In some examples, a user (e.g., a customer) can select a geographic area via a user interface of a computing device (e.g., computing device 102 and/or an external computing device not illustrated in FIG. 1), as is further described in connection with FIG. 2. The selected geographic area can become the geographic monitoring area associated with an event response station 114. For example, a user associated with the event response station 114-1 can specify a geographic area that includes the facility 108-1 and the facility 108-2.

Additionally, the mapping input can include a selection of emergency response units to respond to detected events in the geographic monitoring area. For example, the user can select particular fire engines, ambulances, etc. that can respond to detected events in the geographic monitoring area (e.g., events detected by the control panel 110-1 of facility 108-1 and events detected by the control panel 110-2 of facility 108-2).

Further, the mapping input can include emergency response rules. As used herein, emergency response rules can comprise a set of non-transitory machine-readable instructions that define various conditions that have to be satisfied by input data before corresponding actions can be performed. For example, the emergency response rules can be different programming statements (e.g., if/then statements, among other types of rules) that have to be satisfied prior to the computing device 102 and/or the event response stations 114 take actions. Emergency response rules can be stored in the rules database 106.

For example, a user can specify that if a smoke detector of facility 108-1 detects smoke but a fire detector of the facility 108-1 does not detect fire, then the event response station 114-1 plays a tone and television displays display an alert, but emergency response units are not to be dispatched to the facility 108-1. As another example, a user can specify that a water-flow detector of facility 108-1 detects water flow, do not dispatch emergency response units to the facility 108-1 but if water flow and smoke are detected, dispatch emergency response units to the facility 108-1. As a further example, a user can specify time-based rules so that certain events detected in the facility 108-1 are ignored between the overnight hours of 6 PM and 8 AM, but all events are considered between business hours of 8 AM and 6 PM.

The computing device 102 can generate a predetermined association with the event response station 114-1 and control panels 110-1 and 110-2 in facilities 108-1, 108-2, respectively, using the received mapping input. The mapping input can be stored in the mapping database 104, as illustrated in FIG. 1.

Additionally, although a single predetermined association is described in the example above, embodiments of the disclosure are not so limited. For example, the computing device 102 can manage multiple associations between event response stations and control panels. For instance, a predetermined association can exist between the event response station 114-1 and the control panel 110-1 of facility 108-1, a predetermined association can exist between the event response station 114-2 and the control panel 110-2 of facility 108-2, a predetermined association can exist between the event response station 114-O and the control panel 110-N of facility 108-M, etc. Additionally, as described above, an event response station 114 can include a predetermined association with multiple control panels 110 of multiple facilities 108.

Such an approach can be utilized by event response stations 114 across a geographic region. For instance, a municipality may include multiple event response stations 114, and can easily dictate and define which event response stations 114 are assigned to which facilities 108 via the selected geographic monitoring areas according to the disclosure, as described above and as is further described in connection with FIG. 2.

In operation, the computing device 102 can receive an event notification from a control panel 110 indicating an event was detected in a facility 108. For example, event device 112-1 may be a smoke detector and has detected smoke, and event device 112-2 may be a heat detector and has detected heat. The control panel 110-1 can generate an event notification based on the event devices 112-1 and 112-2 detecting smoke and heat.

As used herein, an event notification refers to an alert comprising information describing a detected occurrence of something. The event notification can include various types of information. For example, the event notification can include an identifier associated with a control panel 110, whether an event was detected by an event device 112, and/or an event type identifier that identifies a type of event device that detected the event, etc.

For instance, the control panel 110-1 can generate an event notification including a unique identifier associated with the control panel 110-1 (e.g., to identify the control panel 110-1 from other control panels 110), that an event was detected by an event device 112 connected to the control panel 110-1, and event type identifiers (e.g., smoke and heat) based on the event device 112-1 being a smoke detector and event device 112-2 being a heat detector. Accordingly, the control panel 110-1 can transmit the event notification to the computing device 102 and the computing device 102 can receive the event notification from the control panel 110-1 indicating an event was detected in the facility 108-1.

Accordingly, the computing device 102 can determine various things from the event notification. For example, the computing device 102 can determine an event response station 114 from a number of event response stations 114 using the mapping database 104 and a type of emergency response unit using the rules database 106, as is further described herein.

The computing device 102 can determine an event response station 114 from a number of event response stations 114 using the mapping database 104. For example, the computing device 102 can determine, based on the received event notification, that an event was detected in facility 108-1 having the control panel 110-1. Using the identifier associated with control panel 110-1, the computing device 102 can determine, using the mapping database 104, that a predetermined association exists between the event response station 114-1 and the control panel 110-1 (e.g., via lookup tables, etc.). Accordingly, the computing device 102 can determine that event response station 114-1 is associated with control panel 110-1.

Additionally, the computing device 102 can determine a type of emergency response unit using the rules database 106. For example, the control panel 110-1 can include a predetermined association with a type of emergency response unit included in the rules database 106, previously described above. For instance, the computing device can determine the type of emergency response unit (e.g., fire engines, EMS, and HAZMAT) associated with the control panel 110-1.

Further, the computing device 102 can determine whether emergency response rules included in the mapping database 104 have been satisfied. For example, the computing device can compare the event notification (e.g., the input data) indicating that smoke and fire have both been detected at the facility 108-1 with the emergency response rules associated with the control panel 110-1 (e.g., if a smoke detector of facility 108-1 detects smoke and a fire detector of the facility 108-1 detects fire, cause television displays to display an alert and dispatch emergency response units to the facility). Based on the comparison indicating the emergency response rules included in the mapping database 104 are satisfied, the computing device 102 can determine an event message should be transmitted to the event response station 114-1.

Accordingly, the computing device 102 can generate an event message. As used herein, an event message can be an alert comprising information describing a detected occurrence of an event. For example, the event message can include a type of event detected, a unique identifier associated with the facility 108-1, and/or a type of emergency response unit to respond to the geographic location of the facility 108-1.

For example, the event message can include the unique identifier associated with the facility 108-1. The unique identifier can be a sequence of characters (e.g., a sequence of letters, numbers, etc.) that is uniquely associated with the facility 108-1 and can be utilized to determine a geographic location of the facility 108-1 (e.g., via a lookup table, etc.). The geographic location can be a specific physical position of a place on the Earth's surface (e.g., the street address, the geospatial coordinates of the facility 108-1 (e.g., geographic positioning system (GPS) coordinates, latitude/longitude coordinates, etc.), etc.). In some examples, the unique identifier can be the geographic location of the facility 108-1. Additionally, the event message can include the type of event (e.g., a fire). Further, the event message can include the type of emergency response unit to respond to the geographic location of the facility 108-1 (e.g., fire engines, EMS, and HAZMAT). Accordingly, the computing device 102 can transmit the event message to the event response station 114-1.

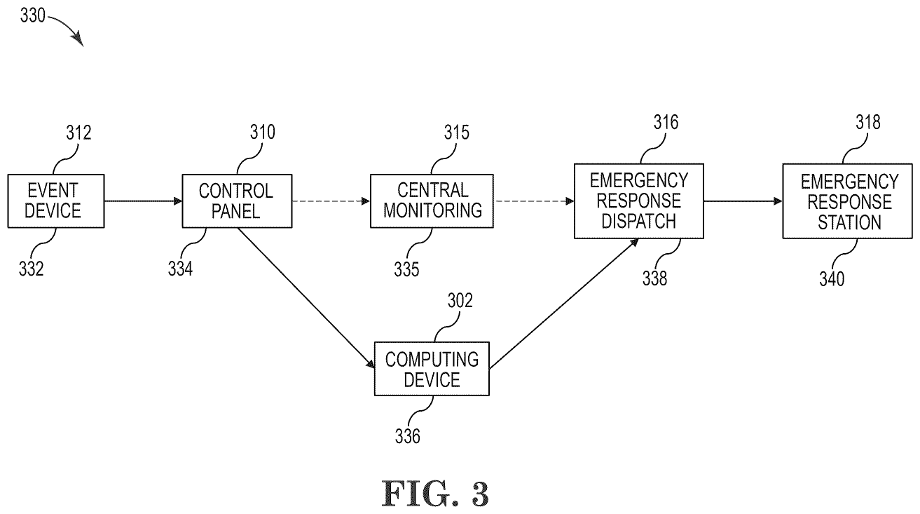

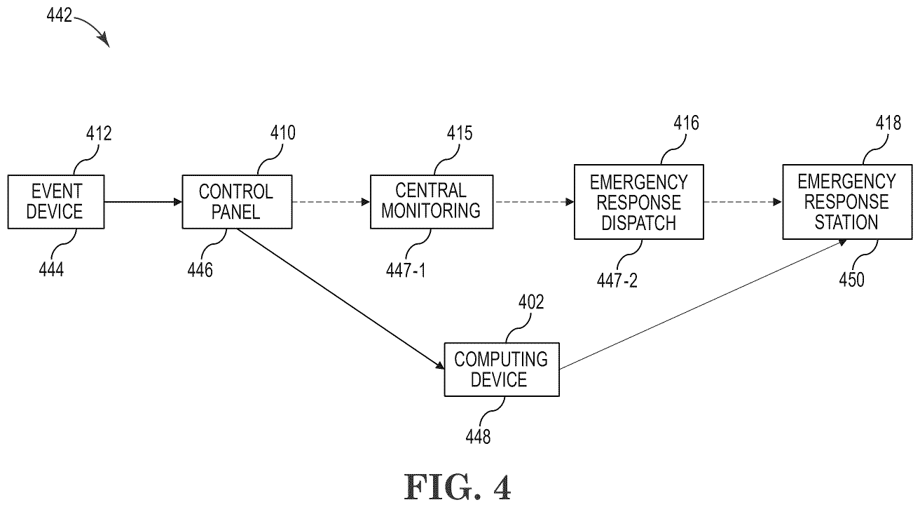

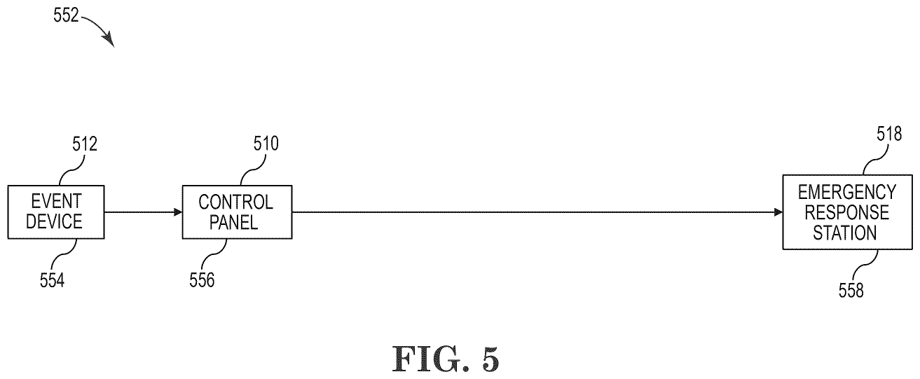

As mentioned above, the event response station 114 can include an emergency response dispatch 116 and/or an emergency response station 118. In some examples, the computing device 102 can transmit the event message to an emergency response dispatch 116, as is further described in connection with FIG. 3. In some examples, the computing device 102 can transmit the event message to an emergency response station 118, as is further described in connection with FIG. 4. In some examples, a control panel 110 can directly transmit an event message to the emergency response station 118, as is further described in connection with FIG. 5.

FIG. 2 is an example of a mapping input 220 for transmitting event messages to event response stations, in accordance with one or more embodiments of the present disclosure. As illustrated in FIG. 2, the mapping input 220 can include selected geographic areas 222 and emergency response units 224.

As previously described in connection with FIG. 1, the computing device (e.g., computing device 102, previously described in connection with FIG. 1) can receive a mapping input. The mapping input can be received from an external computing device and/or directly by the computing device.

The mapping input can define a particular facility (e.g., and control panel) that an event response station monitors and responds to. This definition can be referred to as an association between the control panel and the event response station, and can be defined as is further described herein.

For example, as illustrated in FIG. 2, a user can draw a boundary on a map displayed on a user interface. The boundary can define a geographic monitoring area for a particular (e.g., first) event response station. For example, the geographic monitoring area 222-1 can be a particular shape that encompasses various buildings/facilities within the geographic monitoring area 222-1. As illustrated in FIG. 2, the geographic monitoring area 222-1 can include the facility 208-1 (e.g., among other facilities 208 not illustrated in FIG. 2 for clarity and so as not to obscure embodiments of the disclosure). Accordingly, the first event response station can be associated with a control panel associated with the facility 208-1.

Additionally, the user can draw a boundary on the map for a second event response station that defines geographic monitoring area 222-2. The geographic monitoring area 222-2 can include the facility 208-2. Since the facility 208-2 is located in the selected geographic monitoring area, the second event response station can be associated with a control panel associated with the facility 208-2.

As additionally illustrated in FIG. 2, a number of emergency response units 224 can be selected to respond to detected events in a geographic monitoring area 222. For example, the computing device can receive a selection of emergency response units 224, including fire engines (e.g., E048, E196, E031, etc.) as well as EMS units (e.g., X_MED3, etc.). As such, the selected emergency response units 224 can be included in the predetermined association.

Although not illustrated in FIG. 2, in some examples, the computing device can further generate a different predetermined association with an event response station and a control panel using historical data. For example, historical data may indicate that a particular event response station has responded to events at the facility 208-2 seven times. In response to the number of responses occurring by the event response station to the facility 208-2 exceeding a threshold amount, the computing device can generate a predetermined association between the event response station and the facility 208-2. The generated predetermined association based on historical data can be stored in the mapping database, previously described in connection with FIG. 1.

FIG. 3 is an example of a method 330 for transmitting event messages to event response stations, in accordance with one or more embodiments of the present disclosure. The method 330 can be performed by, for example, a control panel, computing device, and event response station (e.g., control panel 110, computing device 102, event response station 114, previously described in connection with FIG. 1).

At 332, the method 330 includes detecting, by an event device 312, an event at a facility. The event device 312 can transmit information about the detected event to the control panel 310.

At 334, the method 330 includes generating, by the control panel 310, an event notification that an event was detected by the event device 312. The control panel 310 can transmit the event notification to the computing device 302.

At 336, the method 330 includes receiving, by the computing device 302, the event notification from the control panel 310. At 336, the method 330 further includes determining, based on the event notification, an event response station from a number of event response stations using a predetermined association between the control panel 310 and the event response station in a mapping database and a type of emergency response unit using a rules database. The computing device 302 can generate and transmit an event message to an event response station, as is further described herein.

In the method 330 illustrated in FIG. 3, the event response station can be an emergency response dispatch station 316. For example, at 336, the method 330 includes directly transmitting an event message by the computing device 302 to the emergency response dispatch station 316. At 338, the emergency response dispatch station 316 receives the event message. At 340, the method 330 includes transmitting, by the emergency response dispatch station 316, a message to the emergency response station 318 in order to cause emergency response units to be dispatched to the facility to address the detected event.

As illustrated in FIG. 3, in some examples, the method 330 can include transmitting information about the detected event to a central monitoring station 315. Such an approach may be mandated by jurisdictional regulations where the facilities are located. While such an approach may be utilized, the method 330 can be performed in conjunction with the transmission to a central monitoring station 315 in order to satisfy such jurisdictional regulations while also simultaneously providing event messages to emergency response dispatch stations 316 faster and more efficiently than previous approaches.

The method 330 can be utilized by municipalities or other users where the municipality may run the emergency response dispatch stations 316 and/or the emergency response stations 318.

FIG. 4 is an example of a method for transmitting event messages to event response stations, in accordance with one or more embodiments of the present disclosure. The method 442 can be performed by, for example, a control panel, computing device, and event response station (e.g., control panel 110, computing device 102, event response station 114, previously described in connection with FIG. 1).

At 444, the method 442 includes detecting, by an event device 412, an event at a facility. The event device 412 can transmit information about the detected event to the control panel 410.

At 446, the method 442 includes generating, by the control panel 410, an event notification that an event was detected by the event device 412. The control panel 410 can transmit the event notification to the computing device 402.

At 448, the method 442 includes receiving, by the computing device 402, the event notification from the control panel 410. At 448, the method 442 further includes determining, based on the event notification, an event response station from a number of event response stations using a predetermined association between the control panel 410 and the event response station in a mapping database and a type of emergency response unit using a rules database. The computing device 402 can generate and transmit an event message to an event response station, as is further described herein.

In the method 442 illustrated in FIG. 3, the event response station can be an emergency response station 418. For example, at 448, the method 442 includes directly transmitting an event message by the computing device 402 to the emergency response station 418. At 450, the emergency response station 418 receives the event message, and the emergency response station 318 can cause emergency response units to be dispatched to the facility to address the detected event.

As illustrated in FIG. 3, in some examples, the method 442 can include transmitting information about the detected event to a central monitoring station 415. Such an approach may be mandated by jurisdictional regulations where the facilities are located. While such an approach may be utilized, the method 442 can be performed in conjunction with the transmission to a central monitoring station 415 in order to satisfy such jurisdictional regulations while also simultaneously providing event messages to emergency response stations 418 faster and more efficiently than previous approaches.

The method 442 can be utilized by municipalities or other users where the municipality may run the emergency response dispatch stations 416 and/or the emergency response stations 418.

FIG. 5 is an example of a method 552 for transmitting event messages to event response stations, in accordance with one or more embodiments of the present disclosure. The method 552 can be performed by, for example, a control panel, computing device, and event response station (e.g., control panel 110, computing device 102, event response station 114, previously described in connection with FIG. 1).

At 554, the method 552 includes detecting, by an event device 512, an event at a facility. The event device 512 can transmit information about the detected event to the control panel 510.

At 556, the method 552 includes generating, by the control panel 510, an event notification that an event was detected by the event device 512. At 556, the method 552 further includes directly transmitting, by the control panel 510, the event notification directly to the emergency response station 518. At 558, the method 552 includes the emergency response station 518 receiving the event message, and the emergency response station 518 can cause emergency response units to be dispatched to the facility to address the detected event.

The approach illustrated in FIG. 5 may be utilized in an example in which the facility runs its own emergency response station. For example, large manufacturing plants, airports, and/or others may utilize on-site emergency response stations, and as such, can utilize the method 552 to directly alert an emergency response station 518 of a detected event.

Accordingly, transmitting event messages to event response stations according to the disclosure can allow for efficient transmission of event messages from a fire panel to an event response station by including various types of information that can be easily transmitted and analyzed. Emergency response stations can selectively monitor different geographic areas allowing for efficient emergency response coverage for a geographic region. Such an approach can make facilities safer by allowing for faster response to an event by emergency response units, as compared with previous approaches.

FIG. 6 is an example of a computing device 602 for transmitting event messages to event response stations, in accordance with one or more embodiments of the present disclosure. As illustrated in FIG. 6, the computing device 602 can include a memory 664 and a processor 662 for transmitting event messages to event response stations, in accordance with the present disclosure.

The memory 664 can be any type of storage medium that can be accessed by the processor 662 to perform various examples of the present disclosure. For example, the memory 664 can be a non-transitory computer readable medium having computer readable instructions (e.g., executable instructions/computer program instructions) stored thereon that are executable by the processor 662 for transmitting event messages to event response stations in accordance with the present disclosure.

The memory 664 can be volatile or nonvolatile memory. The memory 664 can also be removable (e.g., portable) memory, or non-removable (e.g., internal) memory. For example, the memory 664 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 664 is illustrated as being located within computing device 602, embodiments of the present disclosure are not so limited. For example, memory 664 can also be located internal to another computing resource (e.g., enabling computer readable instructions to be downloaded over the Internet or another wired or wireless connection).

The processor 662 may be a central processing unit (CPU), a semiconductor-based microprocessor, and/or other hardware devices suitable for retrieval and execution of machine-readable instructions stored in the memory 664.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for transmitting event messages to event response stations, comprising:
a memory; and
a processor configured to execute executable instructions stored in the memory to:
receive an event notification from a control panel of a facility indicating an event was detected in the facility;
determine, based on the event notification, an event response station from a number of event response stations using a mapping database, wherein the control panel has a predetermined association with the event response station in the mapping database; and
transmit an event message to the event response station.

2. The computing device of claim 1, wherein the event message includes a unique identifier associated with the facility.

3. The computing device of claim 1, wherein the event message includes a type of event associated with the detected event.

4. The computing device of claim 1, wherein the processor is configured to execute the instructions to determine, based on the event notification, a type of emergency response unit using a rules database to cause an emergency response unit of the determined emergency response unit type to respond to a geographic location of the facility.

5. The computing device of claim 4, wherein the event message includes the type of emergency response unit.

6. The computing device of claim 4, wherein the control panel has a predetermined association with the type of emergency response unit included in the rules database.

7. The computing device of claim 1, wherein the event notification includes at least one of:
a fire panel identifier; and
an event type identifier.

8. The computing device of claim 1, wherein the processor is configured to execute the instructions to receive a mapping input from an external computing device.

9. The computing device of claim 8, wherein the processor is configured to generate, using the mapping input, the predetermined association with the event response station and the control panel in the mapping database.

10. The computing device of claim 8, wherein the mapping input includes at least one of:
a geographic monitoring area in which the facility is located;
a predefined emergency response unit to respond to detected events in the geographic monitoring area; and
emergency response rules.

11. A non-transitory computer readable medium having computer readable instructions stored thereon that are executable by a processor to:
generate, using a received mapping input, a predetermined association with an event response station and a control panel of a facility in a mapping database;
receive an event notification from the control panel indicating an event was detected in the facility;
determine, based on the event notification:
an event response station from a number of event response stations using the predetermined association in the mapping database; and
a type of emergency response unit using a rules database; and
transmit an event message to the event response station, wherein the event message includes at least one of:
a unique identifier associated with the facility;
a type of event associated with the detected event; and
a type of emergency response unit to respond to a geographic location of the facility.

12. The non-transitory computer readable medium of claim 11, wherein the computer readable instructions are executable by the processor to receive the mapping input including a selection of a geographic area via a user interface, wherein the geographic location of the facility is included in the selected geographic area.

13. The non-transitory computer readable medium of claim 11, wherein the computer readable instructions are executable by the processor to receive the mapping input including a selection of a number of emergency response units from the event response station included in the predetermined association.

14. The non-transitory computer readable medium of claim 13, wherein the computer readable instructions are executable by the processor to receive the mapping input including a type of each of the number of emergency response units.

15. The non-transitory computer readable medium of claim 11, wherein the computer readable instructions are executable by the processor to generate, using historical data, a different predetermined association with the event response station and a different control panel in response to a threshold number of responses occurring by the event response station at a different geographic location associated with the different control panel.

16. A system for transmitting event messages to event response stations, comprising:
a control panel included in a facility; and
a computing device included in a cloud computing environment, the computing device configured to:
receive an event notification from the control panel indicating an event was detected in the facility;
determine, based on the event notification:
an event response station from a number of event response stations using a predetermined association between the control panel and the event response station in a mapping database; and
a type of emergency response unit using a rules database; and
transmit an event message to the event response station to cause an emergency response unit of the determined emergency response unit type to respond to a geographic location of the facility, wherein the event message includes at least one of:
a unique identifier associated with the facility;
a type of event associated with the detected event; and
the type of emergency response unit to respond to the geographic location of the facility.

17. The system of claim 16, wherein the computing device is configured to transmit the event message in response to emergency response rules included in the mapping database being satisfied.

18. The system of claim 16, wherein the control panel is configured to directly transmit the event notification to the event response station.

19. The system of claim 16, wherein the event response station is an emergency response dispatch station.

20. The system of claim 16, wherein the event response station is an emergency response station.
